(19) United States
(12) Patent Application Publication
(10) Pub. No.: US 2014/0095012 A1
(43) Pub. Date: Apr. 3, 2014

(54) SYSTEMS AND METHODS FOR PROVIDING A VEHICLE CHECKLIST

(71) Applicant: GULFSTREAM AEROSPACE CORPORATION, Savannah, GA (US)

(72) Inventor: Carl Edward Wischmeyer, Savannah, GA (US)

(73) Assignee: GULFSTREAM AEROSPACE CORPORATION, Savannah, GA (US)

(21) Appl. No.: 13/630,514

(22) Filed: Sep. 28, 2012

(51) Int. Cl. G06F 11/32

(52) U.S. Cl. 701/29.1

(57) ABSTRACT

A system for providing a checklist to an operator of a vehicle includes, but is not limited to, a processor in communication with a display. Operation of at least one component of the vehicle is sensed and provided to the processor. The processor is configured to generate a checklist based at least in part on the operation of the at least one component of the vehicle. The checklist is then displayed on a display for use by the operator of the vehicles.

### TECHNICAL FIELD

The technical field relates generally to systems and methods for providing a checklist used in operation of a vehicle.

### BACKGROUND

Pilots have traditionally utilized paper-based checklists in the operation of the aircraft. These checklists often require the pilot or other crew to analyze multiple components and/or systems before proceeding. Furthermore, the checklists may direct the pilot or other crew to take unnecessary actions or perform redundant tasks. Again, time is often wasted in performing these operations.

As such, it is desirable to present a checklist to an operator of a vehicle which will reduce the time and effort needed to perform the tasks of the checklist. In addition, other desirable features and characteristics will become apparent from the subsequent summary and detailed description, and the appended claims, taken in conjunction with the accompanying drawings and this background.

### BRIEF SUMMARY

A method for providing a checklist to an operator of a vehicle includes the step of sensing operation of at least one component of the vehicle. The method further includes the step of generating a checklist based at least in part on the sensed operation of the at least one component of the vehicle. The method also includes the step of displaying the checklist on a display for use by the operator of the vehicle.

A system for providing a checklist to an operator of a vehicle includes a processor. The processor is configured to sense operation of at least one component of the vehicle and generate a checklist based on the sensed operation of the at least one component of the vehicle. The system also includes a display in communication with the processor and is configured to display the checklist for use by the operator of the vehicle.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block schematic diagram of one embodiment of a system for providing a checklist to an operator of a vehicle;

FIG. 2 is a flowchart showing one embodiment of a method for providing a checklist to the operator of the vehicle; and

FIG. 3 is a view of a display showing one checklist; and

FIG. 4 is a view of the display showing another checklist.

### DETAILED DESCRIPTION

Referring to the Figures, wherein like numerals indicate like parts throughout the several views, a system 100 and methods 200 for providing a dynamic checklist to an operator of a vehicle 102 are shown and described herein.

The vehicle 102 of the illustrated embodiment is an aircraft (not separately numbered) such as an airplane (not separately numbered). However, the system 100 and methods 200 described herein may also be used with vehicles and fixed-systems other than an airplane, including, but certainly not limited to, a helicopter, a boat, a chemical plant, a factory, a power plant, or any other complex machinery.

The vehicle 102 includes at least one component 103 related to operation of the vehicle 102. In the illustrated embodiment, the vehicle 102 includes a plurality of components 103. For instance, when the vehicle 102 is an aircraft, the components 103 may include batteries, an auxiliary power unit (“APU”), landing gear, flaps, brakes, electrical loads, engines, a fuel tank, and/or external lights. Of course, the preceding list of components 103 of an aircraft is not intended to be exhaustive. Numerous other components 103 may be utilized in operation of the vehicle 102.

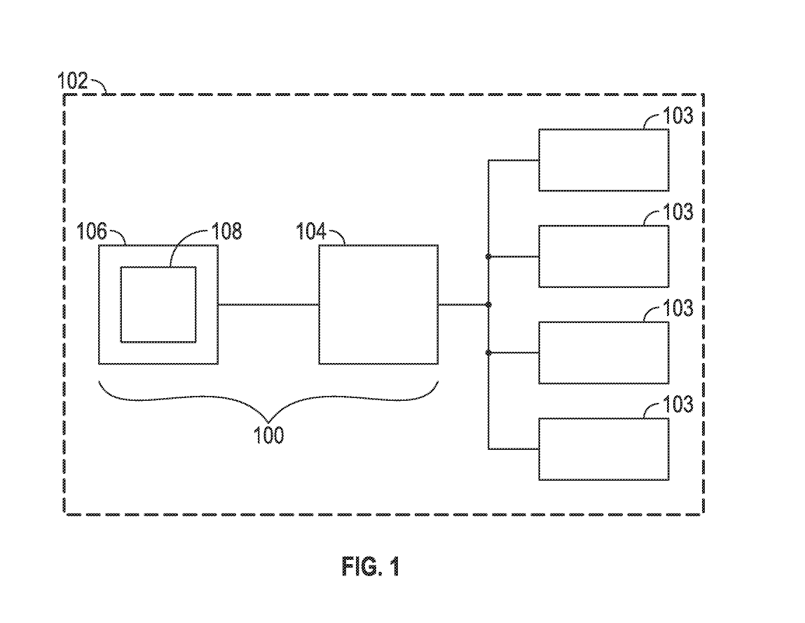

Referring to FIG. 1, the illustrated embodiment of the system 100 includes a controller 104. The controller 104 is a hardware device which carries out instructions of a computer program, as is well known to those skilled in the art. The controller 104 may be implemented with a central processing unit (“CPU”), a microprocessor, an application specific integrated circuit (“ASIC”), a microcontroller, and/or other suitable device. Furthermore, the controller 104 may utilize multiple hardware devices as is also appreciated by those skilled in the art.

The system 100 of the illustrated embodiment further includes a display 106 in communication with controller 104. The display 106 presents visual information, data, and/or instructions to the operator. Particularly, the display 106 operates from instructions provided by the controller 104 and outputs information and data provided by the controller 104. Numerous suitable devices may be utilized as part the display 106, including, but not limited to, a cathode ray tube (“CRT”), light-emitting diodes (“LED”), a plasma panel, and a liquid crystal display (“LCD”). While the system 100 of the illustrated embodiment shows the display 106 as the only output device, other output devices, such as a speaker, may also or alternatively be utilized.

The system 100 of the illustrated embodiment may further include an input device 108 for receiving input from the operator or other user. The input device 108 is in communication with the controller 104 such that input received at the input device 108 may be transmitted to the controller 104. In the illustrated embodiment, the input device 108 is a touch screen panel overlayed with the display 106.

The controller 104 is in communication with the at least one component 103 of the vehicle 102. As such, the controller 104 may receive information, data, and/or commands from the at least one component 103, and vice-versa. Communication with the component 103 may be achieved via direct connection between the controller 104 and the component 103, wireless communications, or communications through one or more intermediary devices (not shown). Those skilled in the art realize any number of techniques to facilitate such communication.

The system 100 described above is capable of and may be configured to implement the steps of the method 200 described below. However, those skilled in the art realize that other systems and hardware may alternatively be used to implement the method 200. Furthermore, the system 100 described above may be configured to perform other items, besides the various steps of the method 200 described below.

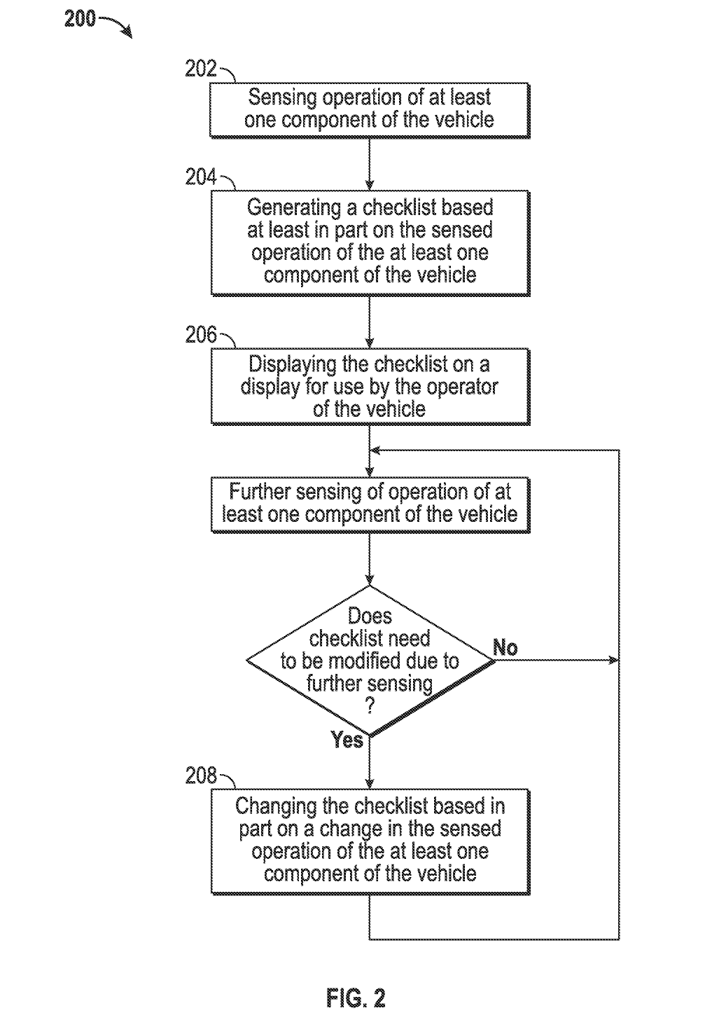

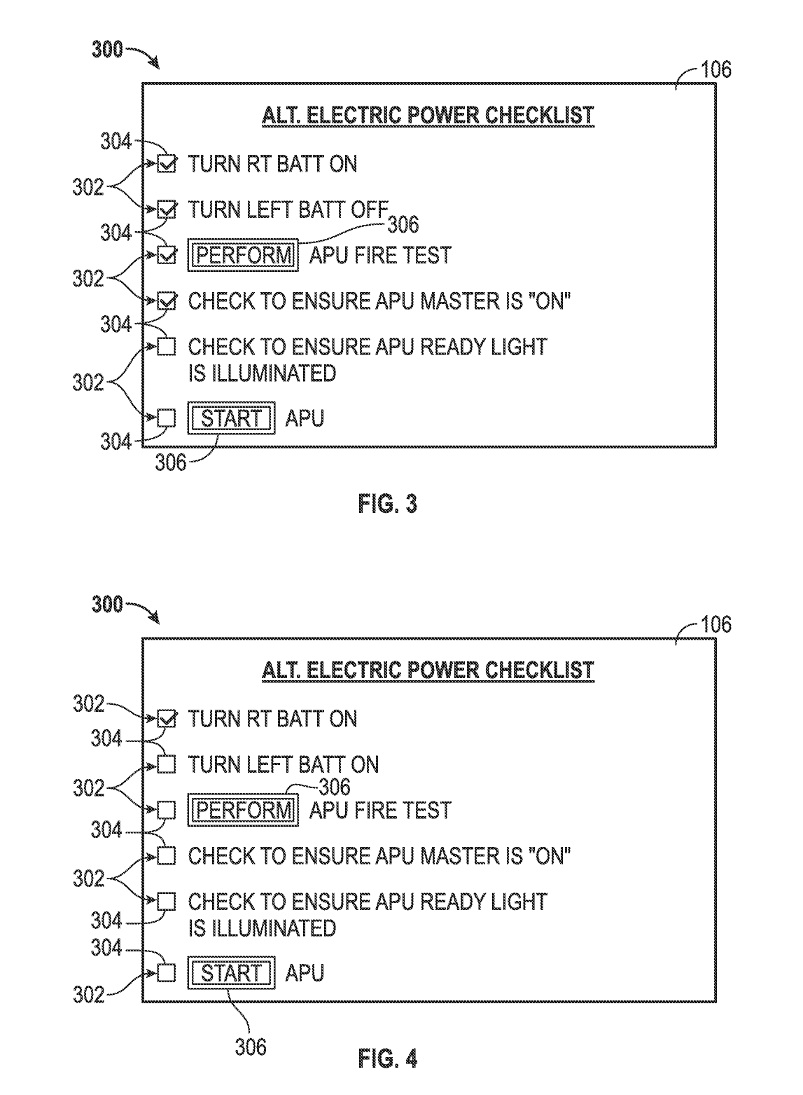

Referring now to FIGS. 2 and 3, the methods 200 for providing a dynamic checklist 300 to the operator of a vehicle 102 include the step 202 of sensing operation of at least one component 103 of the vehicle 102. In some embodiments, where the vehicle 102 has a plurality of components 103, this step 202 may be further defined as sensing operation of a plurality of components 103 of the vehicle 102.

Sensing the operation of the components 103 may be performed differently based on each individual component 103 and the “operation” of the component 103 that is being sensed. In one instance, the step of sensing operation of the component 103 may be further defined as whether or not the component is functional. For example, if the component 103 is a battery, sensing operation of the battery may include sensing whether the battery has a sufficient charge to provide current to various loads of the vehicle 102. In another example, if the component 103 is an engine, sensing operation of the engine may include analyzing one or more signals from the engine to see if the engine is operating properly. The sensing of the operation of each individual component 103 may include sensing the lack of communication with the component 103. For example, if the component 103 fails, is destroyed, and/or is otherwise removed, communication between the component 103 and the controller 104 may be interrupted.

In another instance, sensing the operation of the component 103 may also be defined as sensing the state of the component 103. For example, if the component 103 is landing gear, sensing the operation of the landing gear may be determining whether the landing gear is “up”, “down”, or between states. In another example, if the component 103 is aircraft flaps, sensing the operation of the flaps may be receiving and analyzing a signal which indicates whether the flaps are “set for landing” or “retracted”. Furthermore, sensing the state of the component 103 may involve analyzing signals from multiple sensors (not numbered) for that component 103.

The method 200 also includes the step 204 of generating a checklist 300 for use by the operator of the vehicle. The checklist 300 presents various items for the operator to perform. Accordingly, the method 200 further includes the step 206 of displaying the checklist 300 on the display 106, as shown in FIG. 3, for use by the operator of the vehicle 102. In the illustrated embodiment, multiple checklists are utilized for various aspects of flight of the aircraft. However, the use of the singular term “checklist” as used herein should not be read as limiting.

By generating the checklist 300 based in part on the actual, sensed status of vehicle 102 components 103, unnecessary and otherwise redundant actions, including the use of multiple checklists, are reduced. This saves crucial time and effort, especially in time sensitive circumstances, e.g., the failure of a critical component of the vehicle 102.

The checklists 300 may be divided into two types: (1) regularly scheduled checklists and (2) event-driven checklists. For example, a regularly scheduled checklist may be a pre-takeoff checklist or a pre-landing checklist. An event-driven checklist may be a checklist that is utilized in response to one or more events. For example, there may be an event-driven checklist for the loss of an engine of the aircraft. However, the checklist 300 may have properties of both a regularly scheduled checklist and an event-driven checklist, as described further below.

The checklist 300 generated by the method 200 is based, at least in part, on the sensed operation of the at least one component 103 of the vehicle 102. That is, in the illustrated embodiment, the sensed operation of the component 103 or components 103 are utilized in generating one or more items 302 of the checklist 300. Said yet another way, whether or not an item 302 appears on the checklist 300 may be dependent on the sensed operation of one or more components 103.

For example, in some aircraft, if a certain electrical bus is inoperative, then an automatic pressurization controller, to maintain cabin pressure, is not receiving electrical power. As such, pressurization may have to be set manually. As applied to the method 200, if the component 103 (i.e., the electrical bus) is sensed to be inoperative, then the checklist 300 may include the item 312 of “manually setting cabin pressurization”.

The method may further include the step 208 of changing the checklist 300 based at least in part on a change in the sensed operation of the at least one component 103 of the vehicle 102. The changing of the checklist 300 may include altering at least one of the items 302 based at least in part on a change in the sensed operation of the at least one component 103 of the vehicle 102. Altering at least one of the items 302 may include, but is not limited to, adding an item 302, deleting an item 302, and/or modifying an item 302. For example, with reference to FIGS. 3 and 4, where an aircraft has two main power generators and two sets of batteries, if it is sensed that both generators have failed, then both batteries must be set to “ON”, as shown in FIG. 4.

The items 302 of the checklist 300 may be ranked in a prioritized order. That is, the items may be arranged in an order of which item must be done first, second, and so on. Furthermore, ranking the items 302 in a prioritized order may be based at least in part on the sensed operation of the at least one component 103 of the vehicle 102. Moreover, the items 302 may be arranged and displayed on the display 106 in the prioritized order. In the illustrated embodiment, the highest prioritized item 302 (i.e., the first item) is listed at a top of the display 106, the next highest prioritized item 302 is immediately below the highest prioritized item 302, and so on.

For instance, in an emergency situation, the items 302 may be arranged such that the first item to be performed is critical to the preservation of the vehicle 102 and/or the health and safety of the user. As just one example, if it is sensed that cabin pressure of the aircraft is failing, the checklist 300 may be reprioritized such that first item 302 is for the user (and the rest of the crew) to don an oxygen mask (before they are incapacitated). As another example, if it is sensed that an autopilot mechanism of the aircraft has failed, the checklist 300 may be reprioritized such that first item 302 is to take manual control of the aircraft.

Other criteria for arranging the items 302 of the checklist 300 may also be utilized. In one example, the items 302 may be grouped by overall objective. In another example, the items 302 may be grouped by vehicle 100 “system” so that redundant and/or contradictory steps are avoided. In yet another example, the items 302 may be grouped by “cockpit flow”, such that the items are arranged intuitively based on where an action or analysis must take place in the cockpit of the vehicle 102. In addition, the items 302 of the checklist 300 may be re-ordered according to the required interactions of whatever components 103 are functional. For example, hydraulic systems may need to be energized before brakes are required.

As described above, the checklist 300 may be dynamically changed and/or reprioritized. As such, a regularly scheduled checklist may take on properties of an event-driven checklist. For example, if a pre-landing checklist was being utilized when it is sensed that an essential electrical bus has failed, the items of the checklist may be amended, deleted, changed, and/or reprioritized accordingly.

The method 200 may further include the step (not shown in FIG. 2) of receiving an input from the operator of the vehicle 102. Furthermore, the receiving of the input may be done in response to the displaying of the checklist 300 on the display 106. That is, the system 100 and method 200 may, in addition to just displaying checklists 300, may receive feedback or other commands from the operator. The input from the user may be received with the input device 108, as described above.

The input received may be an acknowledgement that an item 302 has been completed. This may be accomplished by touching a check-box 304 on the touch screen display 106. However, other suitable techniques of acknowledgement will be recognized by those skilled in the art. After acknowledgement is received, the displayed item 302 may be modified in some way to show that the item 302 has been completed and/or acknowledged. For example, a check-mark may be placed in the check-box 304, as shown in FIG. 3. Alternatively, the item may be dimmed on the display or the item may be removed from the display. Of course, other techniques for modifying the displayed item 302 will be realized by those skilled in the art.

The input received may be a command to be sent to a component 103 of the vehicle 102. As such, the method may also include the step of sending a command to at least one component 103 of the vehicle 102 in response to said receiving the input from the operator of the vehicle 102. In the illustrated embodiment, the command is received by the controller 104, processed, and then sent to the proper component 103.

As shown in FIG. 3, the item 302 of “start alternate power unit (APU)” is displayed on the display 106. Also displayed is an icon 306 around the word “start”. When the operator selects (i.e., touches) the icon 306, a command is sent to APU to start the APU. Of course, other suitable situations and techniques to send a command to a component 103 may be implemented as will be realized by those skilled in the art.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method for providing a dynamic checklist for a vehicle, said method comprising the steps of:
sensing an operation of at least one component of the vehicle;
generating a checklist based at least in part on the operation of the at least one component of the vehicle; and
displaying the checklist on a display.

2. A method as set forth in claim 1 further comprising the step of changing the checklist based at least in part on a change in the operation of the at least one component of the vehicle.

3. A method as set forth in claim 2 wherein the checklist includes a plurality of items and wherein said step of changing the checklist further comprises altering at least one of the plurality of items based at least in part on the change in the operation of the at least one component of the vehicle.

4. A method as set forth in claim 1 wherein said step of sensing operation of at least one component of the vehicle is further comprises sensing a functionality of the at least one component.

5. A method as set forth in claim 1 further comprising the step of receiving an input in response to said displaying the checklist on the display.

6. A method as set forth in claim 5 further comprising the step of sending a command to at least one component of the vehicle in response to said receiving the input.

7. A method as set forth in claim 1 wherein the checklist includes a plurality of items and further comprising the step of prioritizing the plurality of items in a prioritized order based at least in part on the operation of the at least one component of the vehicle.

8. A method as set forth in claim 7 wherein said step of displaying the checklist is further defined as the step of displaying the plurality of items of the checklist on the display in the prioritized order.

9. A method for providing a dynamic checklist for a vehicle, said method comprising the steps of:
sensing operation of a plurality of components of the vehicle;
generating a checklist having a plurality of items related to operation of the vehicle;
prioritizing the plurality of items in a prioritized order based at least in part on the operation of the plurality of components of the vehicle; and
displaying the checklist on a display.

10. A method as set forth in claim 9 wherein said step of displaying the checklist is further defined as the step of displaying the plurality of items of the checklist on the display in the prioritized order.

11. A method as set forth in claim 9 further comprising the step of changing the checklist based at least in part on a change in the operation of the at least one component of the vehicle.

12. A method as set forth in claim 11 wherein said step of changing the checklist further comprises altering at least one of the plurality of items based at least in part on the change in the operation of the at least one component of the vehicle.

13. A method as set forth in claim 9 wherein said step of sensing the operation of at least one component of the vehicle is further defined as the step of sensing a functionality of the at least one component.

14. A method as set forth in claim 9 further comprising the step of receiving an input in response to said displaying the checklist on the display.

15. A method as set forth in claim 14 further comprising the step of sending a command to at least one component of the vehicle in response to said receiving the input.

16. A system for providing a dynamic checklist for a vehicle, said system comprising:
a processor configured to sense operation of at least one component of the vehicle and generating a checklist based on the operation of the at least one component of the vehicle; and
a display in communication with said processor and configured to display the checklist.

17. A method as set forth in claim 16 wherein the checklist comprises a plurality of items and said processor is configured to alter at least one of the plurality of items based at least in part on a change in the operation of the at least one component of the vehicle.

18. A method as set forth in claim 16 wherein the checklist comprises a plurality of items and said processor is configured to prioritize the plurality of items in a prioritized order based at least in part on the operation of the at least one component of the vehicle.

19. A method as set forth in claim 18 wherein said display is configured to display the checklist in the prioritized order.
